(19) United States
(12) Patent Application Publication
(10) Pub. No.: US 2015/0230164 A1
(43) Pub. Date: Aug. 13, 2015

(54) METHOD AND SYSTEM FOR MANAGING MULTIPLE ACCESS POINT NAMES

(71) Applicant: Robert Morcos, Miami, FL (US)

(72) Inventor: Robert Morcos, Miami, FL (US)

(21) Appl. No.: 14/177,852

(22) Filed: Feb. 11, 2014

(51) Int. Cl. H04W 48/18; G06F 3/0482; H04M 1/725

(52) U.S. Cl. CPC H04W 48/18; H04M 1/72519; G06F 3/0482

(57) ABSTRACT

A method and system for managing multiple access point names. The method and system serves to install, through preprogramming, a list of access point names (APN's) on a communication device. The method and system also enables a user of the communication device to select at least one APN from the list of APN's, where each APN correlates to a network operator. The user select the appropriate APN, based on the network operator utilized by the user. The selection of the APN from the list of APN's includes choosing an APN from the list by scrolling through a menu on the communication device, and clicking on the desired APN. The selected APN serves as a gateway between a packet data network and another network, such as internet. In this manner, the method and system provides minimal programming and third party assistance to match the APN with a correlating network operator.

### FIELD OF THE INVENTION

The present invention relates generally to a method for managing multiple access point names in a communication device. More so, the method for managing multiple access point names installs a list of access point names on a single communication device, and enables selection of at least one access point name that correlates with at least one network operator.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typically, obtaining wireless services with communication device requires subscribing to a network operator. The network of the network operator, typically includes base stations, access nodes, wireless modems, or the like, for wirelessly communicating with the communication device. The network typically includes gateways to packet data networks (PDNs), such as the Internet, private networks, or the like, which the user equipment can access through the network.

Often, in order for the communication device to access a desired PDN, the communication device typically specifies to the operator network an access point name (APN) that corresponds to the desired PDN. The APN is a coded identifying name of a gateway between the communication device and the network.

It is known that a mobile communication device making a data connection must be configured with the APN to present to the network operator. The network operator will then examine the APN to determine what type of network connection should be created, for example: what IP addresses should be assigned to the wireless device, what security methods should be used, and how or if, it should be connected to some private customer network.

A single APN often resides on each communication device, with the APN representing a correlating network operator. When a user wishes to change network operators, a technical third party is often required to reconfigure the communication device to communicate with the new network operator. This third party involvement is often time consuming and complicated.

In view of the foregoing, it is clear that these traditional techniques are not perfect and leave room for more optimal approaches.

### SUMMARY OF THE INVENTION

This invention is directed to a method for managing multiple access point names (APN's) from a single communication device. The method preprograms a list of APN's on a communication device, and enables selection of at least one APN from the list that correlates with a network operator. In this manner, minimal programming and third party assistance is needed to select and match an APN with a correlating network operator.

In some embodiments, the method may enable installation of a list of APN's on a communication device. The list of APN's correlates to a plurality of network operators that provide the communication device and a packet data network (PDN). In one embodiment, the list of APN's may be sold to a network operator for installation on the communication device. The list of APN's can be programmed into the communication device during or after manufacture. In yet another embodiment, a user of the communication device may install the list of APN's on the communication device, independent of the network operator.

Those skilled in the art will recognize that a communication device must be configured with an appropriate APN to present to the network operator. The network operator will then examine the APN to determine what type of network connection should be created. For example: what internet protocol addresses should be assigned to the communication device, what security methods should be used, and how or if, the APN should be connected to a private customer network.

In some embodiments, the method may further include, a user of the communication device, choosing a specific network operator that offers a PDN and other services. Each network operator may provide different types of PDN's and services. The user may subscribe to the network operator based on the desired type of PDN and service. The PDN may include an internet protocol address, an intranet, and a private network. Other services provided by the network operator may include, without limitation, connection to wireless application protocol server, and multimedia messaging service that are provided by the PDN. The user may factor in these services when choosing the network operator. The selection by the user may include a paid subscription with the network operator for a duration, such as a contract.

In some embodiments, the user determines the appropriate APN from the list of APN's based on the selected network operator. Each network operator has a unique APN. The user may thus, determine at least one APN from the list of APN's on the communication device based on the selected network operator. From this determination, the user may then select the appropriate APN directly or indirectly from the communication device. The list of APN's may be accessible from a settings section in the communication device. In some embodiments, selecting from the list of APN's does not require assistance form a third party. The selected APN can then identify the correlating PDN controlled by the network operator. The user can perform the method with minimal programming or assistance form a third party.

A first aspect of the present invention provides a method for managing multiple access point names from a single communication device, comprising:
installing a list of access point names on a communication device, the list of access point names correlating to a plurality of network operators;
choosing, by a communication device user, a network operator;
determining at least one access point name from the list of access point names, at least partially based on the chosen network operator;
selecting the at least one access point name from the list of access point names; and
accessing a packet data network through the selected access point name.

In a second aspect, the step of installing a list of access point names on a communication device, further comprises preprogramming a software with the list of access point names into the communication device.

In another aspect, the step of installing a list of access point names on a communication device, further comprises preprograming the software on a plurality of communication devices during manufacture.

In another aspect, the access point name comprises an identifier code programmed in the communication device from the network operator.

In another aspect, the access point name comprises i2gold for AT&T® network operator, and epc.tmobile.com for T-Mobile® network operator.

In another aspect, the access point name is configured to allow the communication device to work properly for an internet setting.

In another aspect, the access technology comprises one of the following: a wireless local area network (WLAN), a wired access, a frequency division multiple access (FDMA), an orthogonal frequency division multiple access (OFDMA), a code division multiple access (CDMA), a time division multiple access (TDMA) or a space division multiple access (SDMA).

In another aspect, the communication device comprises a smart phone.

In another aspect, the network operator comprises a mobile network operator.

In another aspect, the network operator comprises a wireless communications services provider that owns a wireless network infrastructure over which wireless services are provided.

In another aspect, the network operator comprises AT&T®, Sprint®, or T-Mobile®.

In another aspect, the step of choosing, by a communication device user, a network operator, further comprises choosing a mobile virtual network operator.

In another aspect, the mobile virtual network operator comprises Lycamobile.

In another aspect, the step of selecting the at least one access point name from the list of access point names, further comprises specifying the access point name that is enabled in the communication device to a network to cause the network to provide the communication device with access to the packet data network that corresponds to the access point name.

In another aspect, the step of selecting the at least one access point name from the list of access point names, further comprises manually selecting the at least one access point name through a radio button.

In another aspect, the step of selecting the at least one access point name from the list of access point names, further comprises the user scrolling from the list of access point numbers.

In another aspect, the step of accessing a packet data network through the selected access point name, further comprises the access point name forming a gateway to pass internet protocol traffic through the packet data network.

In another aspect, the step of accessing a packet data network through the selected access point name, further comprises the network operator determining what internet protocol address should be assigned to the wireless device, what security methods should be used, and how the communication device should be connected to a private customer network.

In another aspect, the packet data network comprises a 3GPP data access network.

These and other advantages of the invention will be further understood and appreciated by those skilled in the art by reference to the following written specification, claims and appended drawings.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a flowchart diagram of an exemplary method for managing multiple access point names, in accordance with an embodiment of the present invention;

FIG. 2 illustrates a block diagram of an exemplary system for managing multiple access point names, in accordance with an embodiment of the present invention; and

FIG. 3 illustrates a block diagram depicting an exemplary client/server system used by an exemplary web-enabled/networked embodiment of a method and system for managing multiple access point names, in accordance with an embodiment of the present invention.

Like reference numerals refer to like parts throughout the various views of the drawings.

### DETAILED DESCRIPTION OF THE INVENTION

The present invention is best understood by reference to the detailed figures and description set forth herein.

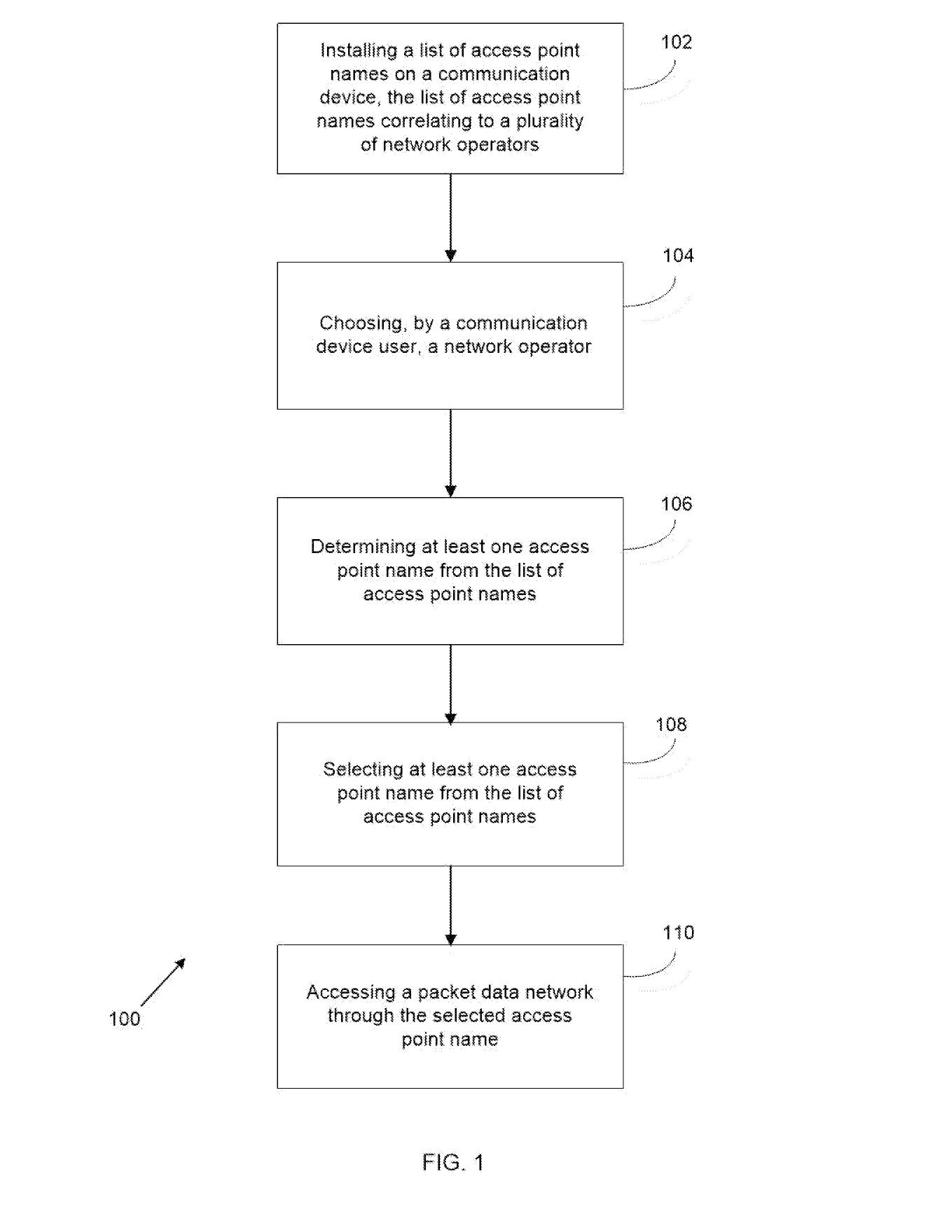

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

In one embodiment of the present invention, referenced in FIG. 1, a method 100 for managing multiple access point names on a communication device provides an efficient and user friendly way to integrate an access point name (APN) 204 into a communication device 206, and then utilize the APN 204 to access a packet data network (PDN) 210 that is provided by a network operator 208. The method 100 preprograms a list of APN's 202 on the communication device 206, and enables a user of the communication device 206 to select at least one APN 204 from the list of APN's 202 that correlates with a network operator 208. The communication device 206 may then be operable to communicate with the PDN 210 offered by the network operator 208. In this manner, minimal programming and third party assistance is needed to select and match the APN 204 with a correlating network operator 208.

The method 100 may include an initial Step 202 of installing a list of APN's 202 on the communication device 206, the list of APN's 202 correlating to a plurality of network operators 208. The method 100 may enable installation of the list of APN's 202 on a communication device 206. The list of APN's 202 may be preprogrammed as a software coded with the list of APN's 202. The list of APN's 202 may be preprogrammed on a plurality of communication devices 206 during manufacture. This mass integration of software onto the communication devices 206 during fabrication may help reduce costs. The software can be coded or downloaded directly onto the communication device 206.

In some embodiments, the list of APN's 202 correlates to a plurality of network operators 208 that provide the communication device 206 and the PDN 210. In one embodiment, the list of APN's 202 may be sold to a network operator 208 for installation on the communication device 206. However, the list of APN's 202 may also be provided to a virtual network operator 208 for installation. The list of APN's 202 can be programmed into the communication device 206 during or after manufacture. In yet another embodiment, a user of the communication device 206 may install the list of APN's 202 on the communication device 206, independent of the network operator 208.

In some embodiments, the APN 204 is a coded identifying name of a gateway between a PDN 210, such as GPRS, 3G or 4G mobile network, and another computer network, such as the public internet. Example of the APN 204 could include, without limitation, i2gold for AT&T® network operator 208, and epc.tmobile.com for T-Mobile® network operator 208. Those skilled in the art will recognize that the access technology comprises one of the following: a wireless local area network (WLAN), a wired access, a frequency division multiple access (FDMA), an orthogonal frequency division multiple access (OFDMA), a code division multiple access (CDMA), a time division multiple access (TDMA) or a space division multiple access (SDMA). The APN 204 is configured to allow the communication device 206 to work properly for an internet setting on any of the above technologies.

Those skilled in the art will recognize that a communication device 206 must be configured with an appropriate APN 204 to present to the network operator 208. The network operator 208 will then examine the APN 204 to determine what type of network connection should be created. For example: what internet protocol addresses should be assigned to the communication device 206; what security methods should be used, and how; or if the APN 204 should be connected to a private customer network. The communication device 206 may include, without limitation, a smart phone, a cellular phone, a laptop, a fax, and a computer.

The method 100 may further comprise a Step 204 of choosing, by a user of a communication device 206, a network operator 208. The user of the communication device 206 may choose a specific network operator 208 that offers a PDN 210 and other services. Each network operator 208 may provide different types of PDNs 210 and services. The user may subscribe to the network operator 208 based on the desired type of PDN 210 and service. The PDN 210 may include an internet protocol address, an intranet, and a private network. Other services provided by the network operator 208 may include, without limitation, connection to wireless application protocol server, and multimedia messaging service that are provided by the PDN 210. The user may factor in these services when choosing the network operator 208. The Step 204 of choosing of the network operator 208 may include a paid subscription with the network operator 208 for a duration, such as a two year contract, for example.

In some embodiments, the network operator 208 comprises a wireless communications services provider that owns a wireless network infrastructure over which wireless services are provided. Examples of network operators 208 may include, without limitation, AT&T®, Sprint®, or T-Mobile®. The network operator 208 may further comprise a mobile virtual network operator 208, such as Lycamobile® that does not own the network, but still offers a PDN 210.

A Step 206 of the method 100 may include determining at least one APN 204 from the list of APN's 202. The determination Step 206 involves specifying the APN 204 that is enabled in the communication device 206 to a network to cause the network to provide the communication device 206 with access to the PDN 210 that corresponds to the APN 204. In some embodiments, the user determines the appropriate APN 204 from the list of APN's 202 based on the network operator 208. Each network operator 208 has a unique APN 204. The user may thus, determine at least one APN 204 from the list of APN's 202 on the communication device 206 based on the selected network operator 208.

In some embodiments, a Step 208 comprises selecting the at least one APN 204 from the list of APN's 202. From the APN 204 determination, the user may then select the appropriate APN 204 directly or indirectly from the communication device 206. The list of APN's 202 may be accessible from a settings section in the communication device 206. In some embodiments, selecting from the list of APN's 202 does not require assistance form a third party. In one embodiment, the user may manually select the at least one APN 204 through a radio button, after scrolling from the list of APN's 202.

A final Step 210 includes accessing the PDN 210 through the selected APN 204. The selected APN 204 can then identify the correlating PDN 210 controlled by the network operator 208. The user can perform the method 100 with minimal programming or assistance form a third party. The APN 204 forms a gateway to pass internet protocol traffic between the PDN 210 and another network, such as an internet. In some embodiments, the network operator 208 may determine what internet protocol address should be assigned to the communication device 206, what security methods should be used, and how the communication device 206 should be connected to a private customer network. The PDN 210 may include, without limitation, a 3GPP, 3G, 4G, or GPRS data access network.

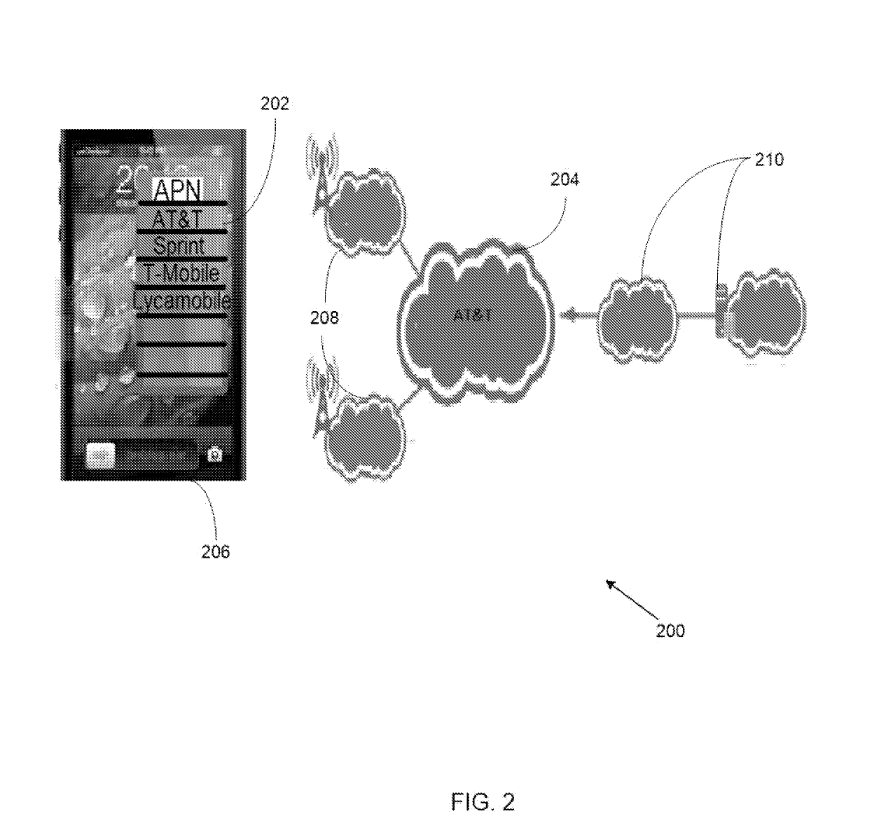

FIG. 2 illustrates a block diagram of an exemplary system 200 for managing multiple APNs 204. The system 200 serves to install, often through preprogramming, a list of APN's 202 on the communication device 206. The system 200 may also enable a user of the communication device 206 to select at least one APN 204 from the list of APN's 202, where each APN 204 correlates to a network operator 208. In this manner, minimal programming and third party assistance is needed to select and match the APN 204 with a correlating network operator 208.

In some embodiments, the system 200 provides an APN 204 that serves as a gateway between the PDN 210 and another network, such as an internet. The system 200 allows the user to select the appropriate APN 204, based on the network operator 208 utilized by the user. The selection of the APN 204 from the list of APN's 202 may include scrolling through a menu, and clicking on the desired APN 204 displayed. Third parties and complicated programming, often encountered on settings found in communication devices 206, may thus be eliminated from the APN 204 selection process.

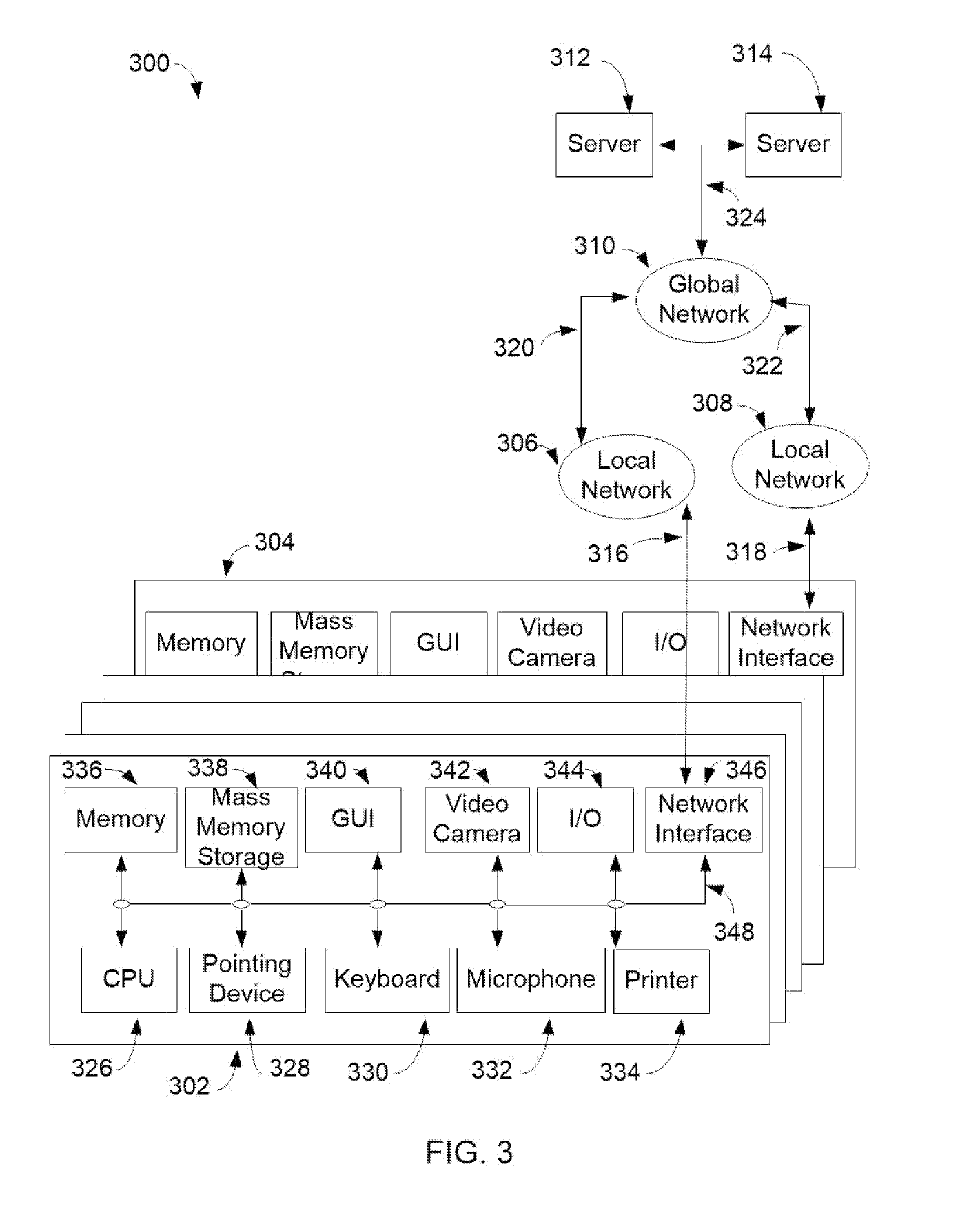

FIG. 3 is a block diagram depicting an exemplary client/server system which may be used by an exemplary web-enabled/networked embodiment of the present invention. In the present invention, a communication system 300 includes a multiplicity of clients with a sampling of clients denoted as a client 302 and a client 304, a multiplicity of local networks with a sampling of networks denoted as a local network 306 and a local network 308, a global network 310 and a multiplicity of servers with a sampling of servers denoted as a server 312 and a server 314.

Client 302 may communicate bi-directionally with local network 306 via a communication channel 316. Client 304 may communicate bi-directionally with local network 308 via a communication channel 318. Local network 306 may communicate bi-directionally with global network 310 via a communication channel 320. Local network 308 may communicate bi-directionally with global network 310 via a communication channel 322. Global network 310 may communicate bi-directionally with server 312 and server 314 via a communication channel 324. Server 312 and server 314 may communicate bi-directionally with each other via communication channel 324. Furthermore, clients 302, 304, local networks 306, 308, global network 310 and servers 312, 314 may each communicate bi-directionally with each other.

In one embodiment, global network 310 may operate as the Internet. It will be understood by those skilled in the art that communication system 300 may take many different forms. Non-limiting examples of forms for communication system 300 include local area networks (LANs), wide area networks (WANs), wired telephone networks, wireless networks, or any other network supporting data communication between respective entities.

Clients 302 and 304 may take many different forms. Non-limiting examples of clients 302 and 304 include personal computers, personal digital assistants (PDAs), cellular phones and smartphones.

Client 302 includes a CPU 326, a pointing device 328, a keyboard 330, a microphone 332, a printer 334, a memory 336, a mass memory storage 338, a GUI 340, a video camera 342, an input/output interface 344 and a network interface 346.

CPU 326, pointing device 328, keyboard 330, microphone 332, printer 334, memory 336, mass memory storage 338, GUI 340, video camera 342, input/output interface 344 and network interface 346 may communicate in a unidirectional manner or a bi-directional manner with each other via a communication channel 348. Communication channel 348 may be configured as a single communication channel or a multiplicity of communication channels.

CPU 326 may be comprised of a single processor or multiple processors. CPU 326 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 336 is used typically to transfer data and instructions to CPU 326 in a bi-directional manner. Memory 336, as discussed previously, may include any suitable computer-readable media, intended for data storage, such as those described above excluding any wired or wireless transmissions unless specifically noted. Mass memory storage 338 may also be coupled bi-directionally to CPU 326 and provides additional data storage capacity and may include any of the computer-readable media described above. Mass memory storage 338 may be used to store programs, data and the like and is typically a secondary storage medium such as a hard disk. It will be appreciated that the information retained within mass memory storage 338, may, in appropriate cases, be incorporated in standard fashion as part of memory 336 as virtual memory.

CPU 326 may be coupled to GUI 340. GUI 340 enables a user to view the operation of computer operating system and software. CPU 326 may be coupled to pointing device 328. Non-limiting examples of pointing device 328 include computer mouse, trackball and touchpad. Pointing device 328 enables a user with the capability to maneuver a computer cursor about the viewing area of GUI 340 and select areas or features in the viewing area of GUI 340. CPU 326 may be coupled to keyboard 330. Keyboard 330 enables a user with the capability to input alphanumeric textual information to CPU 326. CPU 326 may be coupled to microphone 332. Microphone 332 enables audio produced by a user to be recorded, processed and communicated by CPU 326. CPU 326 may be connected to printer 334. Printer 334 enables a user with the capability to print information to a sheet of paper. CPU 326 may be connected to video camera 342. Video camera 342 enables video produced or captured by user to be recorded, processed and communicated by CPU 326.

CPU 326 may also be coupled to input/output interface 344 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 326 optionally may be coupled to network interface 346 which enables communication with an external device such as a database or a computer or telecommunications or internet network using an external connection shown generally as communication channel 316, which may be implemented as a hardwired or wireless communications link using suitable conventional technologies. With such a connection, CPU 326 might receive information from the network, or might output information to a network in the course of performing the method steps described in the teachings of the present invention.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What I claim is:

1. A method for managing multiple access point names from a single communication device, the method comprising:
installing a list of access point names on a communication device, the list of access point names correlating to a plurality of network operators;
choosing, by a communication device user, a network operator;
determining at least one access point name from the list of access point names, at least partially based on the chosen network operator;
selecting the at least one access point name from the list of access point names; and
accessing a packet data network through the selected access point name.

2. The method of claim 1, in which the step of installing a list of access point names on a communication device, further comprises preprogramming a software with the list of access point names into the communication device.

3. The method of claim 2, in which the step of installing a list of access point names on a communication device, further comprises preprograming the software on a plurality of communication devices during manufacture.

4. The method of claim 3, in which the access point name comprises an identifier code programmed in the communication device from the network operator.

5. The method of claim 4, in which the access point name comprises i2gold for AT&T® network operator, and epc.tmobile.com for T-Mobile® network operator.

6. The method of claim 5, in which the access point name is configured to allow the communication device to work properly for an internet setting.

7. The method of claim 6, in which the communication device comprises a smart phone.

8. The method of claim 7, in which the network operator comprises a mobile network operator.

9. The method of claim 8, in which the network operator comprises a wireless communications services provider that owns a wireless network infrastructure over which wireless services are provided.

10. The method of claim 9, in which the network operator comprises AT&T®, Sprint®, or T-Mobile®.

11. The method of claim 10, in which the step of choosing, by a communication device user, a network operator, further comprises choosing a mobile virtual network operator.

12. The method of claim 11, in which the mobile virtual network operator comprises Lycamobile®.

13. The method of claim 12, in which the step of selecting the at least one access point name from the list of access point names, further comprises specifying the access point name that is enabled in the communication device to a network to cause the network to provide the communication device with access to the packet data network that corresponds to the access point name.

14. The method of claim 13, in which the step of selecting the at least one access point name from the list of access point names, further comprises manually selecting the at least one access point name through a radio button.

15. The method of claim 14, in which the step of selecting the at least one access point name from the list of access point names, further comprises scrolling from the list of access point numbers.

16. The method of claim 15, in which the step of accessing a packet data network through the selected access point name, further comprises the access point name forming a gateway to pass internet protocol traffic through the packet data network.

17. The method of claim 16, in which the step of accessing the packet data network through the selected access point name, further comprises the network operator determining what internet protocol address should be assigned to the wireless device, what security methods should be used, and how the communication device should be connected to a private customer network.

18. The method of claim 17, in which the packet data network comprises a 3GPP data access network.

19. One or more computer storage media storing computer-usable instructions, that when used by one or more computing devices, cause the one or more computing devices to perform a method comprising:
(a) installing a list of access point names on a communication device, the list of access point names correlating to a plurality of network operators;
(b) choosing, by a communication device user, a network operator;
(c) determining at least one access point name from the list of access point names, at least partially based on the chosen network operator;
(d) selecting the at least one access point name from the list of access point names; and
(e) accessing a packet data network through the selected access point name.

20. A system for managing multiple access point names from a single communication device, the method comprising:
a list of access point names, the list of access point name comprising an access point name;
a communication device configured to receive and store the list of access point names;
a network operator configured to correlate to the access point name; and
a packet data network configured to communicate with the communication device through the access point name,
wherein selection of the access point name from the list of access point names on the communication device enables communication with the packet data network.
